(19) United States
(12) Patent Application Publication
(10) Pub. No.: US 2020/0380407 A1
(43) Pub. Date: Dec. 3, 2020

(54) GENERALIZED NONLINEAR MIXED EFFECT MODELS VIA GAUSSIAN PROCESSES

(71) Applicant: Microsoft Technology Licensing, LLC, Redmond, WA (US)

(72) Inventors: Chengming Jiang, Sunnyvale, CA (US); Kinjal Basu, Stanford, CA (US); Wei Lu, San Jose, CA (US); Souvik Ghosh, Saratoga, CA (US); Mansi Gupta, Pittsburgh, PA (US)

(21) Appl. No.: 16/430,243

(22) Filed: Jun. 3, 2019

(51) Int. Cl. G06N 20/00; G06N 7/00

(52) U.S. Cl. CPC G06N 20/00; G06N 7/005

(57) ABSTRACT

In an example embodiment, training data is obtained, the training data comprising values for a plurality of different features. Then a global machine learned model is trained using a first machine learning algorithm by feeding the training data into the first machine learning algorithm during a fixed effect training process. A non-linear first random effects machine learned model is trained by feeding a subset of the training data into a second machine learning algorithm, the subset of the training data being limited to training data corresponding to a particular value of one of the plurality of different features.

### TECHNICAL FIELD

The present disclosure generally relates to technical problems encountered in deep personalization on computer networks. More specifically, the present disclosure relates to the use of generalized nonlinear mixed models using Gaussian processes.

### BACKGROUND

The rise of the Internet has occasioned an increase in the use of these online services to perform searches for jobs that have been posted on or linked to by the online services, as well as other types of online information and presentations of information, such as presentation of recommended items in “feeds” on a social networking service.

The searches may either be performed explicitly by, for example, a user typing in a search query looking for particular jobs, or implicitly, by presenting the user with job listings the system thinks the user will be interested in. The latter may be presented in an area of a graphical user interface termed “Jobs You May Be Interested In.” In the case of feeds, the implicit search is performed by identifying social networking content that the system thinks may interest the user and presenting it in the feed.

In either the implicit or explicit case, results are presented based on scoring of potential results using a machine-learned model. In the case of explicit searches, the explicit search query is a large factor in the scoring of the results (which would evaluate match features such as how often terms that appear in the query appear in the results). In the case of implicit searches, match features are not used as no explicit search query is provided, but other features may be evaluated to score the results. For job listings, these may include global features, per-user features, and per-job features.

Historically, algorithms to rank job search results in response to an explicit query have heavily utilized text and entity-based features extracted from the query and job postings to derive a global ranking. However, when such global ranking algorithms are modified to improve certain queries, other queries tend to become degraded. Specifically, the queries that often become degraded are those where personalization is desired. When such text and entity-based features are more difficult to obtain, such as where no explicit query is provided, implicit features may be used.

### BRIEF DESCRIPTION OF THE DRAWINGS

Some embodiments of the technology are illustrated, by way of example and not limitation, in the figures of the accompanying drawings.

FIG. 1 is a block diagram illustrating a client-server system, in accordance with an example embodiment.

FIG. 2 is a block diagram showing the functional components of a social networking service, including a data processing module referred to herein as a search engine, for use in generating and providing search results for a search query, consistent with some embodiments of the present disclosure.

FIG. 3 is a block diagram illustrating an application server module of FIG. 2 in more detail, in accordance with an example embodiment.

FIG. 4 is a block diagram illustrating a job posting result ranking engine of FIG. 3 in more detail, in accordance with an example embodiment.

FIG. 5 is a flow diagram illustrating a method to sort candidate job posting results in an online service, in accordance with an example embodiment.

FIG. 6 is a block diagram illustrating a representative software architecture, which may be used in conjunction with various hardware architectures herein described.

FIG. 7 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

### Overview

One approach for better capturing a user's personal preference for items and an item's specific attraction for users in prediction/recommender systems would be to introduce identification (ID)-level regression coefficients in addition to the global regression coefficients in a GLM setting. Such a solution is known as a generalized linear mixed model (GLMix).

GLMix works by combining a global model (or a global portion of a larger model) and one or more random effect models (or random effect portions of a larger model). The random effect models/portions are able to add the personalization aspects to the larger global model/portion. The global model and the random effect models are linear. This means that the models are designed to describe a continuous response variable as a function of one or more input features. With personalization, however, linear models can sometimes have trouble with subtle distinctions between input features. For example, a user may be interested in feed items related to India, but may hate politics. A linear random effect model may imply that the user is interested in a feed item related to Indian politics because the weight assigned to the India portion of the item is so high given the user's interest in India, but be unable to reflect the dislike the user has for items about politics.

In an example embodiment, non-linearity is introduced into a GLMix model. This allows the model(s) to project points that may not be connected by a straight line. This essentially allows the model to “bend” a function line so that it connects points that are unable to be connected with a straight line.

In an example embodiment, this non-linearity is introduced in the form of a Gaussian process, which is able to approximate a smooth function. This provides the benefit of being able to bring the richness of the class of all smooth functions. The Gaussian process is also suitable for random effect models with small data sizes since the Gaussian process can model the structure more effectively than simple linear functions. Moreover, since each member or item may have a small number of data points, the Gaussian process does not require large matrix inversion and thus is easily scalable.

### DESCRIPTION

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

In an example embodiment, GLMix models are used to improve job listing results. In the context of job searching, one key aspect is to show the best jobs to a user based on his or her query, according to some measure. In one example embodiment, this measure may be quantified as the likelihood of user m applying for job j if served when he or she enters the query q, measured by the binary response yₘⱼₛ. sⱼ denotes the feature vector of job j, which includes features extracted from the job posting, such as the job title, summary, location, desired skills, and experience needed. x_{mjq} represents the overall feature vector for the (m, j, q) triple, which can include user, job, query, and associated context features, and any combination thereof.

Specifically, a GLMix model is trained using sample job posting results and sample user data, including information that particular users applied to particular sample job posting results (or otherwise expressed interest in the results). The GLMix model is then trained on the space of job features in addition to a global model. This allows finer signals in the training data to be captured, thus allowing for better differentiation on how the presence of a particular job skill, as opposed to another skill, should generate job posting results. Further, the GLMix model is trained on the space of user features in addition to the global model and the job-features aspect. This allows for better differentiation on how the presence of particular job attributes should generate job posting results.

In an example embodiment, predictions/recommendations are made even more accurate by using three models instead of a single GLMix model. Specifically, rather than having a single GLMix model with different coefficients for users and items, three separate models are used and then combined. Each of these models has different granularities and dimensions. A global model may model the similarity between user attributes (e.g., from the member profile or activity history) and item attributes. A per-user model may model user attributes and activity history. A per-item model may model item attributes and activity history. Such a model may be termed a Generalized Additive Mixed Effect (GAME) model.

In the context of a job search result ranking or recommendation, this results in the following components:
a global model that captures the general behavior of how members apply for jobs
a member-specific model with parameters (to be learned from data) specific to the given member to capture member's personal behavior that deviates from the general behavior, and
a job-specific model with parameters (to be learned from data) specific to the given job to capture the job's unique behavior that deviates from the general behavior.

It should be noted that the global models and random effects models can be thought of as different models whose results are combined, or may be thought of as different portions of the same larger model. This distinction is largely semantic, as the implementation and effect would be the same in either case. For purposes of this disclosure, the terms are used interchangeably (e.g., sometimes it is referred to as a random effects portion and sometimes as a random effects model).

The following is a description of how a GAME model enables such a level of personalization. Let yₘⱼₜ denote the binary response of whether user m would apply for job j in context t, where the context usually includes the time and location where the job is shown. qₘ is used to denote the feature vector of user m, which includes the features extracted from the user's public profile, e.g., the member's title, job function, education history, industry, etc. sⱼ is used to denote the feature vector of job j, which includes features extracted from the job post, e.g. the job title, desired skills and experiences, etc. Let xₘⱼₜ represent the overall feature vector for the (m, j, t) triple, which can include qₘ and sⱼ for feature-level main effects, the outer product between qₘ and sⱼ for interactions among member and job features, and features of the context. It may be assumed that xₘⱼₜ does not contain member IDs or item IDs as features, because IDs will be treated differently from regular features. The GAME model for predicting the probability of user m applying for job j using logistic regression is:

g(E[yₘⱼₜ])=xₘⱼₜ′b+sⱼ′αₘ+qₘ′βⱼ

where g

$$( E [ {y}_{m j t} ] ) = log \frac{E [ {y}_{mjt} ]}{1 - E [ {y}_{mjt} ]}$$

is the link function, b is the global coefficient vector (also called fixed effect coefficients; and αₘ and βⱼ are the coefficient vectors specific to user m and job j, respectively. αₘ and βⱼ are called random effect coefficients, which capture user m's personal preference on different item features and job j's attraction for different member features. For a user m with many responses to different items in the past, this is able to accurately estimate her personal coefficient vector αₘ and provide personalized predictions. On the other hand, if user m does not have much past response data, the posterior mean of αₘ will be close to zero, and the model for user m will fall back to the global fixed effect component x′ₘⱼₜb. The same behavior applies to the per-job coefficient vector βⱼ.

However, for large data sets with a large number of ID-level coefficients, fitting a GLMix model or GAME model can be computationally challenging, especially as the solution scales.

In an example embodiment, the scalability bottleneck is overcome by applying parallelized block coordinate descent under a Bulk Synchronous Parallel (BSP) paradigm.

As described briefly above, in some example embodiments, the scalability bottleneck is overcome by applying parallelized block coordinate descent under a bulk synchronous parallel (BSP) paradigm. Traditionally, the fitting algorithms for random effect models required random effect coefficients Γ to be integrated out either analytically or numerically, which becomes infeasible when facing industry-scale large data sets. Similarity, both deterministic and Markov chain Monte Carlo (MCMC) sampling that operate on Γ as a whole become cumbersome.

In an example embodiment, a parallel block-wise coordinate descent-based iterative conditional mode process may be used, where the posterior mode of the random effect coefficients Γᵣ, for each random effect r, is treated as a block-wise coordinate to be optimized in the space of unknown parameters. Given the scores, the optimization problems for updating the fixed effects b and the random effects Γᵣ are as follows:

$$b = arg {max}_{b} \{ log p ( b ) + {\sum }_{n ϵΩ} log p ( {y}_{n} \vert {s}_{n} - {x}_{n}^{′} {b}^{old} + {x}_{n}^{′} b ) \}$$

$${γ}_{rl} = arg {max}_{{γ}_{rl}} \{ log p ( {γ}_{rl} ) + {\sum }_{n \vert i ( r , n ) = l} log p ( {γ}_{rl} ) + {\sum }_{n \vert i ( r , n ) = l} log p ( {y}_{n} \vert {s}_{n} - {z}_{rn}^{′} {γ}_{rl}^{old} + {z}_{rn}^{′} {γ}_{rl} ) \}$$

Incremental updates for s={sₙ}_{n∈Ω} may be performed for computational efficiency. More specifically, when the fixed effects b get updated, sₙ^{new}=sₙ^{old}−xₙ′b^{old}+xₙ′b_{new} may be applied for updating s, and when the random effects Γ get updated, sₙ^{new}=sₙ^{old}−zᵣₙ′γ_{r,i(r,n)}^{old}+zᵣₙ′γ_{r,i(r,n)}^{new} may be used.

At iteration k of the model algorithm: (E[yₘⱼₜ])=xₘⱼₜ′b+sⱼ′αₘ+qₘ′βⱼ, let s^{k} denote the current value of s={sₙ}ₙ∈Ψ. Let P denote the dimension of fixed effect feature space, i.e., xₙ∈ [symbol] ^{P} and Pᵣ denote the dimension of the feature space for random effect r, i.e., zᵣₙ∈ [symbol] ^{P}^{ᵣ}. C denotes the overall dimension of the feature space, for example

$$C = P + {\sum }_{r ϵℛ} {P}_{r} {N}_{r} ,$$

where Nᵣ denotes the number of random effects of type r (e.g., number of users). For the set of sample responses y(Ω)={yₙ}_{n∈Ω,}|Ω|, is used to denote the size of Ω, i.e., the total number of training samples. Additionally, | [symbol] | is the number of types of random effects, and M is the number of computing nodes in the cluster. These numbers can be used to compute the network input/output cost of the disclosed techniques, with this network input/output cost typically being one of the major technical challenges in scaling up in a distributed computing environment.

The process involves preparing the training data for fixed effect model training with scores, updating the fixed effect coefficients (b), and updating the scores s. Then the training data for random effects model training is prepared with scores and the random effect coefficients and scores are updated. The random effects model training and updating can then continue for each additional random effects model.

The general formulation of GLMix is defined as

$$logit ( {p}_{n} ) = G ( {x}_{n} , b ) + {\sum }_{r ϵℛ} {f}_{r , i ( r , n )} ( {z}_{rn} )$$

Here, G(xn;b) is an unknown function of known form that depends on unknown parameters b. For instance, G could be a composition of linear model, GBDT or DNNs. On the other hand, frl are specific functions that depend on the covariate vector. For example if R={member, item}, fnember,i, fitem,j denotes the functions for the i-th member and j-th item respectively.

In GLMix, one assumes

f_{member,i}(z_{item,n})=z_{item,n}^{T}βᵢ

f_{item,j}(z_{member,n})=z_{member,n}^{T}αⱼ

where βᵢ and αⱼ denote unknown parameter vectors associated with user i and item j, respectively. These user- and item-specific local linear terms provide necessary residual user- and item-specific personalization that may not be captured through the global term G. To perform regularization, L2 penalties are imposed on the α's and β's. This is what makes the model a personalization engine.

In an example embodiment, GLMix is modified to introduce a Gaussian process, with a general formulation of [symbol] ˜GP( [symbol] ) where θᵣₗ are the parameters that specify the kernel function. In addition to being more flexible, Gaussian processes also provide estimates of uncertainty in closed form. Also, Gaussian processes are known to be difficult to scale for large datasets. In an example embodiment, however, a Gaussian process is fitted for each r∈R, [symbol] ℑ{1, . . . , Nr}. Every individual Gaussian process is based on a small number of data points, hence scalability is not an issue.

It may be assumed that [symbol] is a GP on item covariate space zₘ with kernel [symbol] (zᵣₙ_{₁}, zᵣₙ_{₂}), where [symbol] are kernel parameters for user i. In order to borrow strength across user kernels, a prior distribution π ( [symbol] ) is imposed and the hyperparameters [symbol] are estimated using an empirical Bayes approach.

In many cases, the dimension of zₘ could be very large and heterogeneous. This would make [symbol] very high dimensional and add to computational difficulty. For instance, if one selects a radial basis function as the kernel with different length parameter for each dimension, the number of unknowns is equal to the dimension of zₘ. This is prohibitive in problems with large dimension.

In an example embodiment, dimension reduction is incorporated along with, if necessary, feature selection, as part of the model itself. Instead of modelling the Gaussian process on zₘ, a transformation urn=g(zₘ, w) is performed, where g is a known function that depends on unknown parameter vector w.

The key is to assume g and w are global and apply to all Gaussian processes [symbol] , and they are also learned as part of the fitting process. Some examples of g are
linear projection Awᵣₙ, where w=A is a matrix of some lower dimension learned from data,
w could be a random projection,
g could be a neural network and would give rise to deep kernels.

The overall model may be specified as:

[symbol]

(⋅)˜N(0, [symbol] ) for r∈ [symbol] , [symbol] ={0, . . . ,Nᵣ}

where [symbol] are matrices whose n₁, n₂-th entries are [symbol] (zᵣₙ_{₁},zᵣₙ_{₂}). Note that each [symbol] can potentially be of a different length. The length of the vector depends on the number of zᵣₙ such that i(r, n)= [symbol] .

If all of them are stacked, the entire function can be written as,

$$f = ( \begin{matrix}{f}_{1 , 1} \\ {f}_{1 , 2} \\ ⋮ \\ {f}_{r 𝓁} \\ ⋮ \\ {f}_{R , {N}_{R}}\end{matrix} ) \sim N ( 0 , [ \begin{matrix}{K}_{1 , 1} & 0 & … & … & … & 0 \\ 0 & {K}_{1 , 2} & … & … & … & 0 \\ ⋮ & ⋮ & ⋱ & ⋮ & ⋮ & ⋮ \\ ⋮ & ⋮ & ⋮ & {K}_{r 𝓁} & ⋮ & ⋮ \\ 0 & 0 & … & … & … & {K}_{R , {N}_{R}}\end{matrix} ] ) .$$

Simplifying the notation, the above mean vector may be denoted as 0 and the covariance matrix as \tilde{K}. Thus, this leaves f˜N(0, \tilde{K}). With this, notation, the distribution of f given X, θ can be written as

$$log p ( f \vert X , Θ ) = - \frac{1}{2} {f}^{T} {\tilde{K}}^{- 1} f - \frac{1}{2} log \vert \tilde{K} \vert + C = - \frac{1}{2} {\sum }_{r ϵℛ} {\sum }_{𝓁 = 1}^{{N}_{r}} {f}_{r 𝓁}^{T} {K}_{r , 𝓁}^{- 1} {f}_{r 𝓁} - \frac{1}{2} {\sum }_{r ϵℜ} {\sum }_{𝓁 = 1}^{{N}_{r}} log \vert {K}_{r , 𝓁} \vert + C$$

where the last equality follows from the properties of block diagonal matrices. With these preliminaries, the main steps of the learning algorithm can be described.

Learning the parameters in this kind of a model is a challenging task. It may be first described without any dimension reduction or nonlinear mapping g. These further complexities will be described later.

The parameters in the model so far can be written as b, f, Θ= [symbol] , where Θᵣ= [symbol] . b, f, Θ can be obtained by maximizing the following problem:

$${max}_{b , f , Θ} ( log p ( y \vert b , f ) + log ( f \vert Θ ) + log p ( b ) + {\sum }_{r ϵℜ} {\sum }_{𝓁 = 1}^{{N}_{r}} log p ( {θ}_{r 𝓁} ) )$$

A cyclic parallel block-wise coordinate descent can be performed to find all of the optimal parameters. The first step towards solving the above is to estimate a \hat{f}. Note that coordinate descent can be used to obtain f using the following equations.

$${f}_{r 𝓁} = {argmax}_{{f}_{r 𝓁}} ( {\sum }_{n \vert i ( r , n ) = 𝓁} log p ( {y}_{n} \vert {s}_{n} - {f}_{rl}^{old} ( {z}_{rn} ) + {f}_{r 𝓁} ( {z}_{rn} ) ) - \frac{1}{2} {f}_{r 𝓁}^{T} {K}_{{θ}_{rt}}^{- 1} {f}_{r 𝓁} )$$

where

$${s}_{n} = G ( {x}_{n} , b ) + {\sum }_{r ∈ ℜ} {f}_{r , i ( r n )} ( {z}_{r n} ) .$$

The update equations are now given by:

$$b = {argmax}_{b} ( log p ( b ) + {\sum }_{n ϵΩ} log p ( {y}_{n} \vert {s}_{n} - G ( {x}_{n} , {b}^{old} ) + G ( {x}_{n} , b ) ) )$$

$${θ}_{r 𝓁} = {argmax}_{{θ}_{rt}} ( log p ( {θ}_{r 𝓁} ) - \frac{1}{2} {\hat{f}}_{r 𝓁}^{T} {K}_{{θ}_{r 𝓁}}^{- 1} {\hat{f}}_{r 𝓁} - \frac{1}{2} log \vert {K}_{{θ}_{r 𝓁}} \vert )$$

Similar to the procedure in GLMix, when b is updated sₙ may be updated as follows

sₙ=sₙ^{old}−G(xₙ,b^{old})+G(xₙ,b^{new})

and when f is updated it may use

sₙ=sₙ^{old}f_{r,i(r,n)}^{old}(zᵣₙ)+f_{r,i(r,n)}^{new}(zᵣₙ)

The overall algorithm may be described as follows:

Algorithm 1 Parallel Block-wise Coordinate Descent for GNOME

1: Input (yₙ, xₙ)_{nϵΩ} and initial values of b, f, Θ
2: Output \hat{b}, \hat{f}, \hat{Θ}
3: while Not Converged do
4: Update b as in (8)
5: for n ϵ Ω in parallel do
6: Update sₙ as in (10)
7: end for
8: for r ϵ [symbol] do
9: for [symbol] ϵ {1, ..., Nᵣ} in parallel do
10: Update fᵣₗ as in (7)
11: Update θᵣₗ as in (9)
12: end for
13: for n ϵ Ω in parallel do
14: Update sₙ as in (11)
15: end for
16: end for
17: end while

Once the model has been trained, all the model parameters, \hat{b}, \hat{f}, \hat{Θ} are known. If it is assumed that there is a situation where for member [symbol] , it would be desirable to rank different items {n₁, . . . [symbol] }, based on this model. To do so, a new feature vector xₖ=(x_{g}, [symbol] , zₖ) is scored for k=n₁, . . . , [symbol] . Note that since the same member [symbol] , is being scored, the member feature y [symbol] would remain the same in all feature vectors. The score of the row is denoted as

s(xₖ)=G(xₖ,\hat{b})+ [symbol] (zₖ)+\hat{f}_{item,k}(y [symbol] )

It may be assumed that getting the first term is a simple scoring of the model G. To get the second and third terms, note that
[symbol] where

[symbol]

=( [symbol] (z_{r,n}_{₁},z_{r,n}), [symbol] (z_{r,n}_{₂},z_{r,n}), . . . , [symbol] (z_{r,n}_{ᵣ},z_{r,n}))

and z_{r,n}_{₁}, . . . , z_{r,n}_{ᵣ} are the training data features for training [symbol] . To scale the scoring problem, the [symbol] should be precomputed and scored. Based on this, the scoring function becomes,

s(xₖ)=(G(xₖ,\hat{b})+ [symbol] (zₖ)^{T} [symbol] +k_{θ}_{_{item,k}}(zₖ)^{T}ξ_{item,k}

So far the model and the algorithm work directly on the features, zᵣₙ. Now a function g can be adaptively learned, which changes the feature space from zᵣₙ to uᵣₙ=gᵣ(zᵣₙ, wᵣ) for some parameter wᵣ, for r∈ [symbol] . The primary aim of this [symbol] modification is to prevent overfitting and improve computation complexity.

Here gᵣ can be any function that is parametrized by wᵣ. As the first step the same GLMix model is considered, but it uses these transformed parameters.

The following model may be trained

$$logit ( {p}_{n} ) = G ( {x}_{n} , b ) + {\sum }_{r ϵ ℜ} {{g}_{r} ( {z}_{r n} , {w}_{r} )}^{T} {γ}_{r , i ( r , n )}$$

where the parameters are b, w, Γ which can solve using the following optimization problem

$${max}_{b , w , Γ} ( {\sum }_{n} log p ( {y}_{n} \vert {s}_{n} ) + log p ( b ) + {\sum }_{r ϵℜ} {\sum }_{𝓁 = 1}^{{N}_{r}} log p ( {γ}_{r 𝓁} ) )$$

$$where$$

$${s}_{n} = G ( {x}_{n} , b ) + {\sum }_{r ϵ ℜ} {{g}_{r} ( {z}_{rn} , {w}_{r} )}^{T} {γ}_{r , i ( r , n )}$$

To find the optimal parameters the following problems may be solved. The optimizers for wᵣ can be written as

$${w}_{r} = {argmax}_{{w}_{r}} ( log p ( {w}_{r} ) + {\sum }_{n ϵΩ} log p ( {y}_{n} \vert {s}_{n} - {( {g}_{r} ( {z}_{rn} , {w}_{r}^{old} ) - {g}_{r} ( {z}_{rn} , {w}_{r} ) )}^{T} {γ}_{r , i ( r , n )} ) )$$

and the update equation for sₙ can be written as

sₙ=sₙ^{old}−(gᵣ(zᵣₙ,wᵣ^{old})−gᵣ(zᵣₙ,wᵣ))^{T}γ_{r,i}(r,n)

Thus, the overall algorithm is as follows

Algorithm 2 Parallel Block-wise Coordinate Descent for GLMix

1: Input (yₙ, xₙ)_{nϵΩ}
2: Output \hat{b}, ŵ, \hat{Γ}
3: while Not Converged do
4: Update b as in (7) in [3]
5: for n ϵ Ω in parallel do
6: Update sₙ as in (9) in [3]
7: end for
8: for r ϵ [symbol] do
9: Update wᵣ as in (16)
10: for n ϵ Ω in parallel do
11: Update sₙ as in (17)
12: end for
13: for [symbol] ϵ {1, ..., Nᵣ} in parallel do
14: Update γᵣₗ as in (8) {3]
15: end for
16: for n ϵ Ω in parallel do
17: Update sₙ as in (10) [3]
18: end for
19: end for
20: end while

There are several choices of the functions. A few examples include:
w can be a simplex weight. For example:

gᵣ(zᵣₙ,wᵣ)=wᵣ·zᵣₙ
where wᵣ∈Δ.
w could be a simplex weight through a random projection.

For example:

gᵣ(zᵣₙ,wᵣ)=\sqrt{2} cos(∈^{T}(wᵣ·zᵣₙ)+b)
where ∈˜N(0,I) and b˜U(0, 2π) and wᵣ ∈Δ.
gᵣ could be a linear projection such as gᵣ=Aᵣzᵣₙ where this Aᵣ is learned globally with appropriate priors such as the PCA.
gᵣ could be a neural network and wᵣ can be the parameters that define the weights/architecture of the network

Once the above formulation has succeeded, the non-parametric setup can be combined with the automatic variable selection to come up with the final model. The overall model in this setup can be written as:

$$logit ( {p}_{n} ) = G ( {x}_{n} , b ) + {\sum }_{r ∈ ℜ} {f}_{r , i ( r , n )} ( {g}_{r} ( {z}_{rn} , {w}_{r} ) ) .$$

To solve this problem, the overall algorithm is similar to the ones before with a slight modification. The detailed steps are given below.

Algorithm 3 Deep GNOME

1: Input (yₙ, xₙ)_{nϵΩ}
2: Output \hat{b}, \hat{f}, ŵ, \hat{Θ}
3: while Not Converged do
4: Update b as in (8)
5: for n ϵ Ω in parallel do
6: Update sₙ as in (10)
7: end for
8: for r ϵ [symbol] do
9: Update wᵣ as in (16)
10: for n ϵ Ω in parallel do
11: Update sₙ as in (17).
12: end for
13: for [symbol] ϵ {1, ..., Nᵣ} in parallel do
14: Update θᵣₗ as in (9)
15: Update fᵣₗ as in (7)
16: end for
17: for n ϵ Ω in parallel do
18: Update sₙ as in (11)
19: end for
20: end for
21: end while

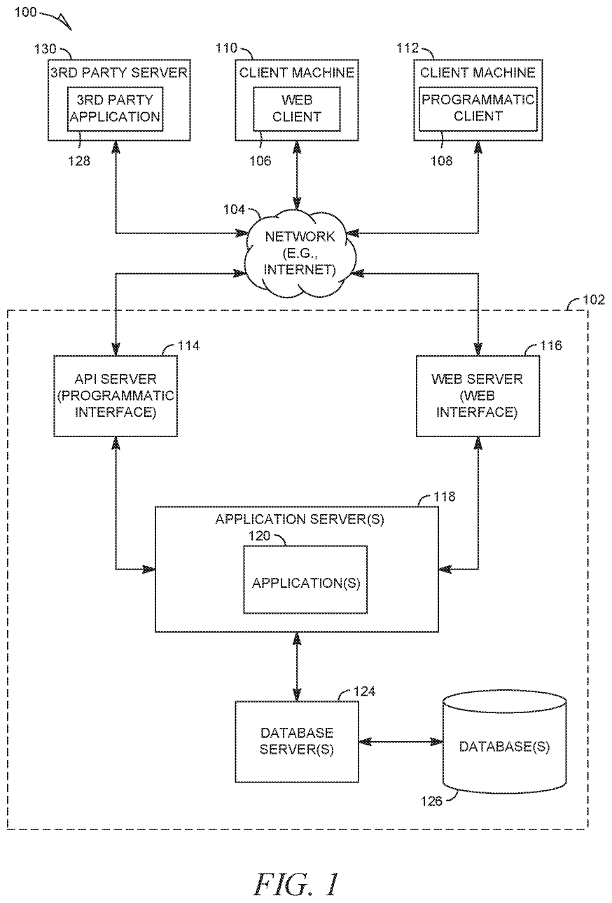

FIG. 1 is a block diagram illustrating a client-server system 100, in accordance with an example embodiment. A networked system 102 provides server-side functionality via a network 104 (e.g., the Internet or a wide area network (WAN)) to one or more clients. FIG. 1 illustrates, for example, a web client 106 (e.g., a browser) and a programmatic client 108 executing on respective client machines 110 and 112.

An application program interface (API) server 114 and a web server 116 are coupled to, and provide programmatic and web interfaces respectively to, one or more application servers 118. The application server(s) 118 host one or more applications 120. The application server(s) 118 are, in turn, shown to be coupled to one or more database servers 124 that facilitate access to one or more databases 126. While the application(s) 120 are shown in FIG. 1 to form part of the networked system 102, it will be appreciated that, in alternative embodiments, the application(s) 120 may form part of a service that is separate and distinct from the networked system 102.

Further, while the client-server system 100 shown in FIG. 1 employs a client-server architecture, the present disclosure is, of course, not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the application(s) 120 via the programmatic interface provided by the API server 114.

FIG. 1 also illustrates a third-party application 128, executing on a third-party server 130, as having programmatic access to the networked system 102 via the programmatic interface provided by the API server 114. For example, the third-party application 128 may, utilizing information retrieved from the networked system 102, support one or more features or functions on a website hosted by a third party. The third-party website may, for example, provide one or more functions that are supported by the relevant applications 120 of the networked system 102.

In some embodiments, any website referred to herein may comprise online content that may be rendered on a variety of devices including, but not limited to, a desktop personal computer (PC), a laptop, and a mobile device (e.g., a tablet computer, smartphone, etc.). In this respect, any of these devices may be employed by a user to use the features of the present disclosure. In some embodiments, a user can use a mobile app on a mobile device (any of the machines 110, 112 and the third-party server 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

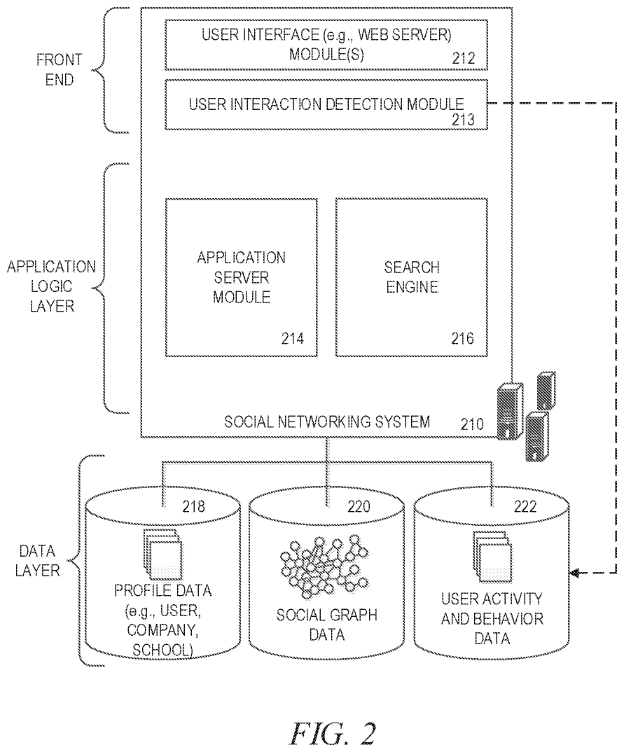

In some embodiments, the networked system 102 may comprise functional components of a social networking service. FIG. 2 is a block diagram showing the functional components of a social networking service, including a data processing module referred to herein as a search engine 216, for use in generating and providing search results for a search query, consistent with some embodiments of the present disclosure. In some embodiments, the search engine 216 may reside on the application server(s) 118 in FIG. 1. However, it is contemplated that other configurations are also within the scope of the present disclosure.

As shown in FIG. 2, a front end may comprise a user interface module (e.g., a web server 116) 212, which receives requests from various client computing devices, and communicates appropriate responses to the requesting client devices. For example, the user interface module(s) 212 may receive requests in the form of Hypertext Transfer Protocol (HTTP) requests or other web-based API requests. In addition, a user interaction detection module 213 may be provided to detect various interactions that users have with different applications 120, services, and content presented. As shown in FIG. 2, upon detecting a particular interaction, the user interaction detection module 213 logs the interaction, including the type of interaction and any metadata relating to the interaction, in a user activity and behavior database 222.

An application logic layer may include one or more various application server modules 214, which, in conjunction with the user interface module(s) 212, generate various user interfaces (e.g., web pages) with data retrieved from various data sources in a data layer. In some embodiments, individual application server modules 214 are used to implement the functionality associated with various applications 120 and/or services provided by the social networking service.

As shown in FIG. 2, the data layer may include several databases 126, such as a profile database 218 for storing profile data, including both user profile data and profile data for various organizations (e.g., companies, schools, etc.). Consistent with some embodiments, when a person initially registers to become a user of the social networking service, the person will be prompted to provide some personal information, such as his or her name, age (e.g., birthdate), gender, interests, contact information, home town, address, spouse's and/or family users' names, educational background (e.g., schools, majors, matriculation and/or graduation dates, etc.), employment history, skills, professional organizations, and so on. This information is stored, for example, in the profile database 218. Similarly, when a representative of an organization initially registers the organization with the social networking service, the representative may be prompted to provide certain information about the organization. This information may be stored, for example, in the profile database 218, or another database (not shown). In some embodiments, the profile data may be processed (e.g., in the background or offline) to generate various derived profile data. For example, if a user has provided information about various job titles that the user has held with the same organization or different organizations, and for how long, this information can be used to infer or derive a user profile attribute indicating the user's overall seniority level, or seniority level within a particular organization. In some embodiments, importing or otherwise accessing data from one or more externally hosted data sources may enrich profile data for both users and organizations. For instance, with organizations in particular, financial data may be imported from one or more external data sources and made part of an organization's profile. This importation of organization data and enrichment of the data will be described in more detail later in this document.

Once registered, a user may invite other users, or be invited by other users, to connect via the social networking service. A “connection” may constitute a bilateral agreement by the users, such that both users acknowledge the establishment of the connection. Similarly, in some embodiments, a user may elect to “follow” another user. In contrast to establishing a connection, the concept of “following” another user typically is a unilateral operation and, at least in some embodiments, does not require acknowledgement or approval by the user that is being followed. When one user follows another, the user who is following may receive status updates (e.g., in an activity or content stream) or other messages published by the user being followed, or relating to various activities undertaken by the user being followed. Similarly, when a user follows an organization, the user becomes eligible to receive messages or status updates published on behalf of the organization. For instance, messages or status updates published on behalf of an organization that a user is following will appear in the user's personalized data feed, commonly referred to as an activity stream or content stream. In any case, the various associations and relationships that the users establish with other users, or with other entities and objects, are stored and maintained within a social graph in a social graph database 220.

As users interact with the various applications 120, services, and content made available via the social networking service, the users' interactions and behavior (e.g., content viewed, links or buttons selected, messages responded to, etc.) may be tracked, and information concerning the users' activities and behavior may be logged or stored, for example, as indicated in FIG. 2, by the user activity and behavior database 222. This logged activity information may then be used by the search engine 216 to determine search results for a search query.

In some embodiments, the databases 218, 220, and 222 may be incorporated into the database(s) 126 in FIG. 1. However, other configurations are also within the scope of the present disclosure.

Although not shown, in some embodiments, the social networking system 210 provides an API module via which applications 120 and services can access various data and services provided or maintained by the social networking service. For example, using an API, an application may be able to request and/or receive one or more navigation recommendations. Such applications 120 may be browser-based applications 120, or may be operating system-specific. In particular, some applications 120 may reside and execute (at least partially) on one or more mobile devices (e.g., phone or tablet computing devices) with a mobile operating system. Furthermore, while in many cases the applications 120 or services that leverage the API may be applications 120 and services that are developed and maintained by the entity operating the social networking service, nothing other than data privacy concerns prevents the API from being provided to the public or to certain third parties under special arrangements, thereby making the navigation recommendations available to third-party applications 128 and services.

Although the search engine 216 is referred to herein as being used in the context of a social networking service, it is contemplated that it may also be employed in the context of any website or online services. Additionally, although features of the present disclosure are referred to herein as being used or presented in the context of a web page, it is contemplated that any user interface view (e.g., a user interface on a mobile device or on desktop software) is within the scope of the present disclosure.

In an example embodiment, when user profiles are indexed, forward search indexes are created and stored. The search engine 216 facilitates the indexing and searching for content within the social networking service, such as the indexing and searching for data or information contained in the data layer, such as profile data (stored, e.g., in the profile database 218), social graph data (stored, e.g., in the social graph database 220), and user activity and behavior data (stored, e.g., in the user activity and behavior database 222), as well as job postings. The search engine 216 may collect, parse, and/or store data in an index or other similar structure to facilitate the identification and retrieval of information in response to received queries for information. This may include, but is not limited to, forward search indexes, inverted indexes, N-gram indexes, and so on.

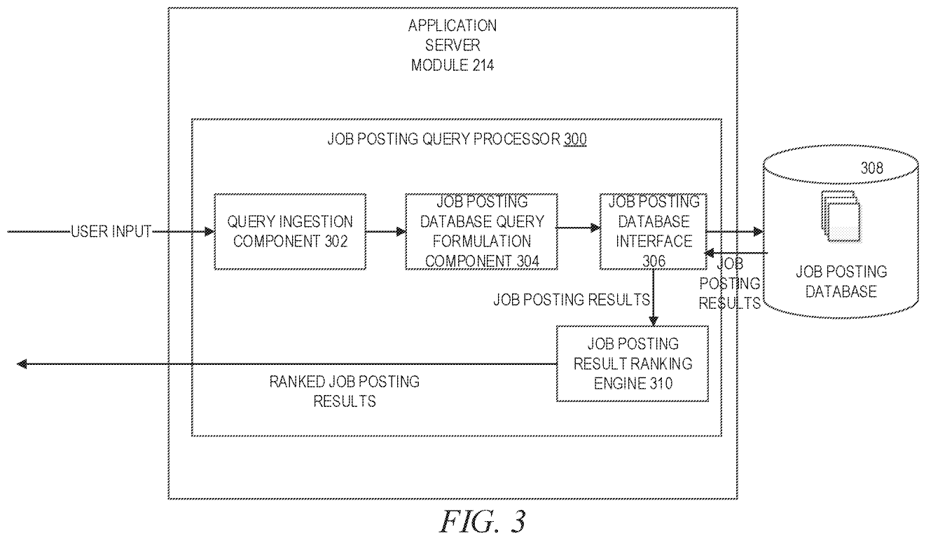

FIG. 3 is a block diagram illustrating application server module 214 of FIG. 2 in more detail, in accordance with an example embodiment. While, in many embodiments, the application server module 214 will contain many subcomponents used to perform various different actions within the social networking system, in FIG. 3 only those components that are relevant to the present disclosure are depicted. A job posting query processor 300 comprises a query ingestion component 302, which receives a user input “query” related to a job posting search via a user interface (not pictured). Notably, this user input may take many forms. In some example embodiments, the user may explicitly describe a job posting search query, such as by entering one or more keywords or terms into one or more fields of a user interface screen. In other example embodiments, the job posting query may be inferred based on one or more user actions, such as selection of one or more filters, other job posting searches by the user, searches for other users or entities, etc.

This “query” may be sent to a job posting database query formulation component 304, which formulates an actual job posting database query, which will be sent via a job posting database interface 306 to job posting database 308. Job posting results responsive to this job posting database query may then be sent to the job posting result ranking engine 310, again via the job posting database interface 306. The job posting result ranking engine 310 then ranks the job posting results and sends the ranked job posting results back to the user interface for display to the user.

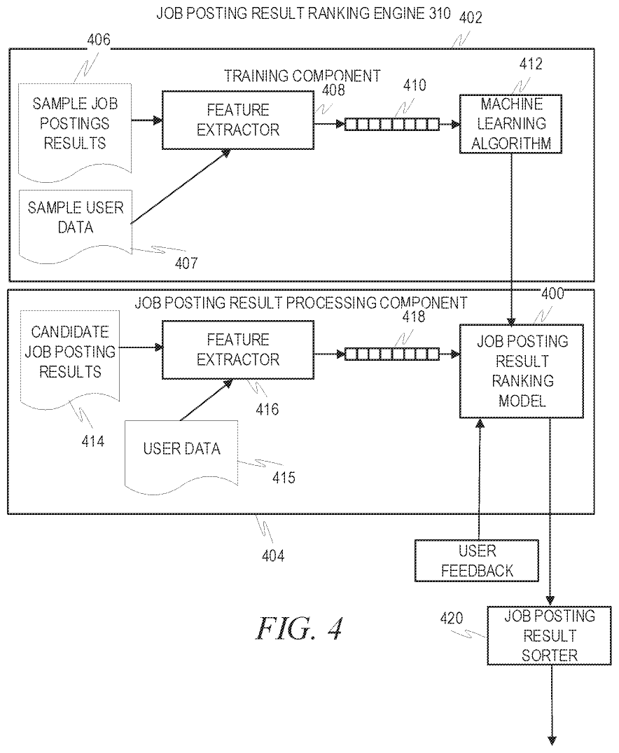

FIG. 4 is a block diagram illustrating job posting result ranking engine 310 of FIG. 3 in more detail, in accordance with an example embodiment. The job posting result ranking engine 310 may use machine learning techniques to learn a job posting result ranking model 400, which can then be used to rank actual job posting results from the job posting database 308.

The job posting result ranking engine 310 may comprise a training component 402 and a job posting result processing component 404. The training component 402 feeds sample job postings results 406 and sample user data 407 into a feature extractor 408 that extracts one or more features 410 for the sample job postings results 406 and sample user data 407. The sample job postings results 406 may each include job postings results produced in response to a particular query as well as one or more labels, such as a job posting application likelihood score, which is a score indicating a probability that a user with a corresponding sample user data 407 will apply for the job associated with the corresponding sample job postings result 406.

Sample user data 407 may include, for example, a history of job searches and resulting expressions of interest (such as clicking on job posting results or applications to corresponding jobs), in particular job posting results for particular users. In some example embodiments, sample user data 407 can also include other data relevant for personalization of the query results to the particular user, such as a user profile for the user or a history of other user activity.

A machine learning algorithm 412 produces the job posting result ranking model 400 using the extracted features 410 along with the one or more labels. In the job posting result processing component 404, candidate job postings results 414 resulting from a particular query are fed to a feature extractor 416 along with candidate user data 415. The feature extractor 416 extracts one or more features 418 from the candidate job postings results 414 and candidate user data 415. These features 418 are then fed to the job posting result ranking model 400, which outputs a job posting application likelihood score for each candidate job postings result for the particular query.

This job posting application likelihood score for each candidate job postings result may then be passed to a job posting result sorter 420, which may sort the candidate job postings results 414 based on their respective job posting application likelihood scores.

It should be noted that the job posting result ranking model 400 may be periodically updated via additional training and/or user feedback. The user feedback may be either feedback from users performing searches, or from companies corresponding to the job postings. The feedback may include an indication about how successful the job posting result ranking model 400 is in predicting user interest in the job posting results presented.

The machine learning algorithm 412 may be selected from among many different potential supervised or unsupervised machine learning algorithms 412. Examples of supervised learning algorithms include artificial neural networks, Bayesian networks, instance-based learning, support vector machines, random forests, linear classifiers, quadratic classifiers, k-nearest neighbor, decision trees, and hidden Markov models. Examples of unsupervised learning algorithms include expectation-maximization algorithms, vector quantization, and information bottleneck method. In an example embodiment, a multi-class logistical regression model is used.

In an example embodiment, the machine learning algorithm 412 actually is two (or more) different machine learning algorithms for different portions of the job posting result ranking model 400. For example, a first machine learning algorithm may be used to train a global portion while a second machine learning algorithm may be used to train a random effects portion. In such cases, the algorithm(s) used to train the random effect portion(s) is/are non-linear, such as via a Gaussian Process.

As described above, the training component 402 may operate in an offline manner to train the job posting result ranking model 400. The job posting result processing component 404, however, may be designed to operate in either an offline manner or an online manner.

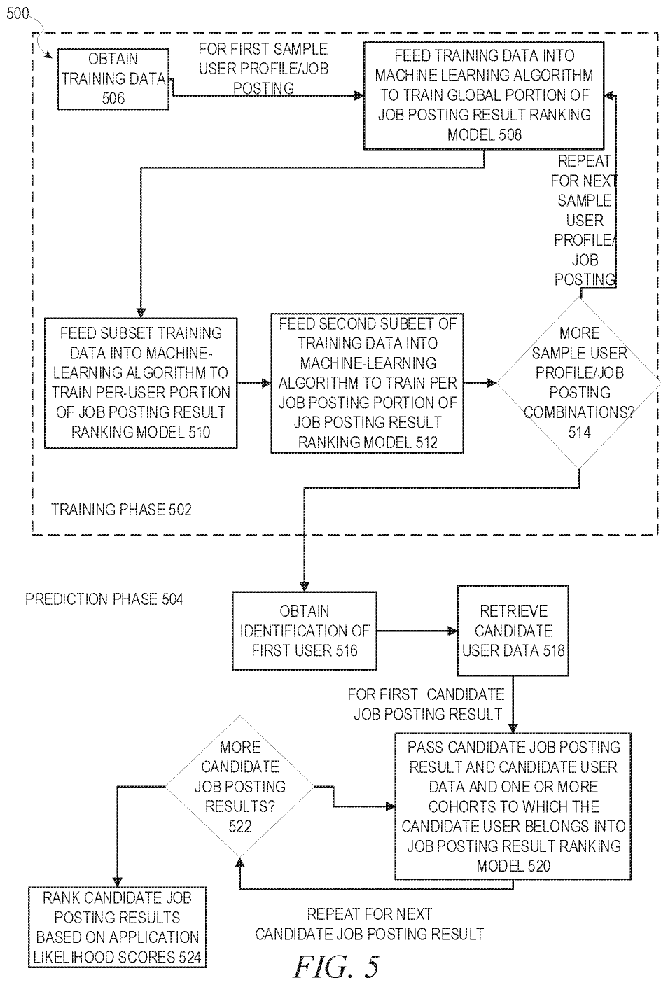

FIG. 5 is a flow diagram illustrating a method 500 to sort candidate job posting results in an online service, in accordance with an example embodiment. This method 500 may be divided into a training phase 502 and a prediction phase 504. In the training phase 502, at operation 506, training data pertaining to sample user profiles and corresponding job posting combinations are obtained. These combinations reflect actions taken by the users corresponding to the sample user profiles to the corresponding job postings. These actions may either be positive or negative, thus indicating positive or negative signals to the underlying machine learning algorithm that will utilize them. The signals may be explicit, including positive signals such as applying for a job corresponding to a job posting or saving a job posting, or negative signals such as dismissing a job (these actions all being taken in a corresponding graphical user interface by, for example, selecting explicit buttons corresponding to these actions), or implicit, including positive signals such as viewing a job posting for a particular period of time or negative signals such as skipping over a job posting.

Then a loop is begun for each of the sample user profile/job posting combinations. At operation 508, the corresponding training data is fed into a machine learning algorithm 412 to train a global portion of a job posting result ranking model 400 to output a job posting application likelihood score for a candidate job posting result and candidate user data 415. At operation 510, a subset of the training data is fed into the machine-learning algorithm to train a per-user portion of the job posting result ranking model. This subset of the training data is limited to the training data corresponding to a particular user. More generically this may be thought of as being limited to a particular value (here the particular user id) of one of the features of the training data (here the user id feature).

Then, at operation 512, a second subset of the training data is fed into the machine learning algorithm to train a per-job-posting portion of the job posting result ranking model. This second subset of the training data is limited to the training data corresponding to a particular job posting. More generically this may be thought of as being limited to a particular value (here the job posting id) of another of the features of the training data (here the job posting id feature).

At operation 514, it is determined if there are any more sample user profile/job posting combinations. If so, the method 500 may loop back to operation 508 for the next sample user profile/job posting combination. If not, then the method 500 may move to the prediction phase 504.

Turning to the prediction phase 504, at operation 516, an identification of a first user of the social networking service is obtained. At operation 518, candidate user data 415 for the first user is retrieved using the identification. Then a loop is begun for each of a plurality of different candidate job posting results 414 retrieved in response to a candidate query from the first user. At operation 520, the candidate job posting result 414 and the candidate user data 415 for the first user, as well as one or more cohorts to which the candidate user belongs, are passed to the job posting result ranking model 400 to generate a job posting application likelihood score for the candidate job posting result 414 and the first user. This involves passing the candidate job posting result and candidate user data 415 to the global and random effect portion(s) of the model, outputting a score for each portion. These scores are then combined into a single job posting application likelihood score. At operation 522, it is determined if there are any more candidate job posting results 414. If so, then the method 500 may loop back to operation 520 for the next candidate job posting result 414. If not, then at operation 524, the plurality of different candidate job posting results 414 are ranked based on the application likelihood scores.

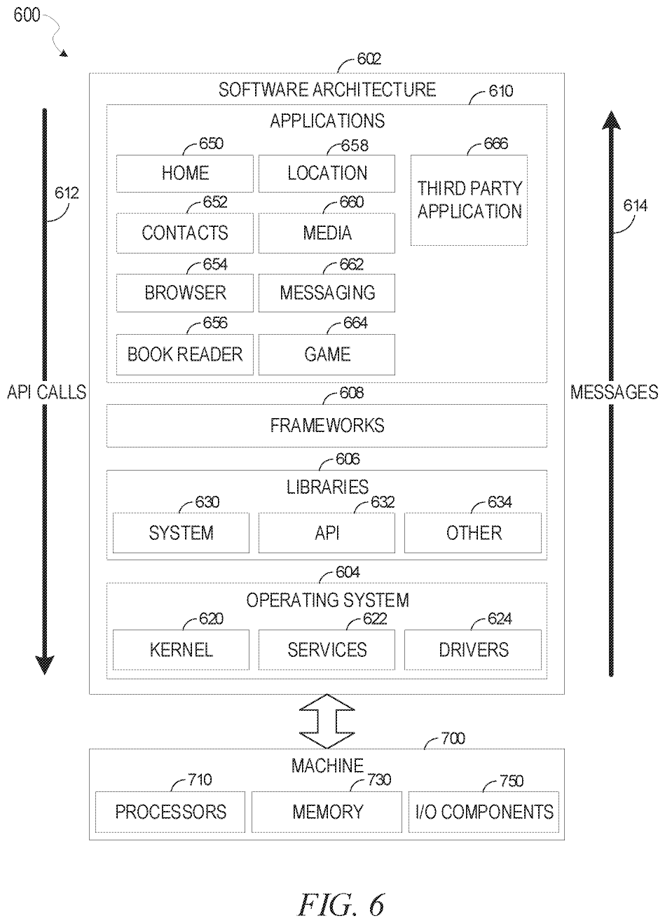

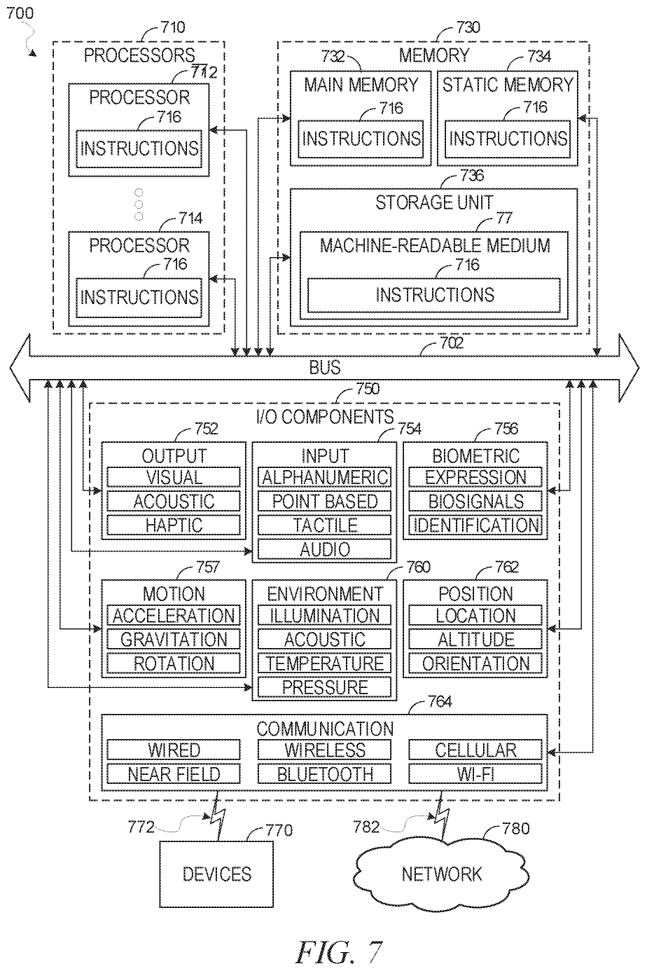

FIG. 6 is a block diagram 600 illustrating a software architecture 602, which can be installed on any one or more of the devices described above. FIG. 6 is merely a non-limiting example of a software architecture, and it will be appreciated that many other architectures can be implemented to facilitate the functionality described herein. In various embodiments, the software architecture 602 is implemented by hardware such as a machine 700 of FIG. 7 that includes processors 710, memory 730, and input/output (I/O) components 750. In this example architecture, the software architecture 602 can be conceptualized as a stack of layers where each layer may provide a particular functionality. For example, the software architecture 602 includes layers such as an operating system 604, libraries 606, frameworks 608, and applications 610. Operationally, the applications 610 invoke API calls 612 through the software stack and receive messages 614 in response to the API calls 612, consistent with some embodiments.

In various implementations, the operating system 604 manages hardware resources and provides common services. The operating system 604 includes, for example, a kernel 620, services 622, and drivers 624. The kernel 620 acts as an abstraction layer between the hardware and the other software layers, consistent with some embodiments. For example, the kernel 620 provides memory management, processor management (e.g., scheduling), component management, networking, and security settings, among other functionality. The services 622 can provide other common services for the other software layers. The drivers 624 are responsible for controlling or interfacing with the underlying hardware, according to some embodiments. For instance, the drivers 624 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 606 provide a low-level common infrastructure utilized by the applications 610. The libraries 606 can include system libraries 630 (e.g., C standard library) that can provide functions such as memory allocation functions, string manipulation functions, mathematic functions, and the like. In addition, the libraries 606 can include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 606 can also include a wide variety of other libraries 634 to provide many other APIs to the applications 610.

The frameworks 608 provide a high-level common infrastructure that can be utilized by the applications 610, according to some embodiments. For example, the frameworks 608 provide various GUI functions, high-level resource management, high-level location services, and so forth. The frameworks 608 can provide a broad spectrum of other APIs that can be utilized by the applications 610, some of which may be specific to a particular operating system 604 or platform.

In an example embodiment, the applications 610 include a home application 650, a contacts application 652, a browser application 654, a book reader application 656, a location application 658, a media application 660, a messaging application 662, a game application 664, and a broad assortment of other applications, such as a third-party application 666. According to some embodiments, the applications 610 are programs that execute functions defined in the programs. Various programming languages can be employed to create one or more of the applications 610, structured in a variety of manners, such as object-oriented programming languages (e.g., Objective-C, Java, or C++) or procedural programming languages (e.g., C or assembly language). In a specific example, the third-party application 666 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 666 can invoke the API calls 612 provided by the operating system 604 to facilitate functionality described herein.

FIG. 7 illustrates a diagrammatic representation of a machine 700 in the form of a computer system within which a set of instructions may be executed for causing the machine to perform any one or more of the methodologies discussed herein, according to an example embodiment. Specifically, FIG. 7 shows a diagrammatic representation of the machine 700, in the example form of a computer system, within which instructions 716 (e.g., software, a program, an application 610, an applet, an app, or other executable code) for causing the machine 700 to perform any one or more of the methodologies discussed herein may be executed. For example, the instructions 716 may cause the machine 700 to execute the method 500 of FIG. 5. Additionally, or alternatively, the instructions 716 may implement FIGS. 1-5, and so forth. The instructions 716 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a PC, a tablet computer, a laptop computer, a netbook, a set-top box (STB), a portable digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory 730, and I/O components 750, which may be configured to communicate with each other such as via a bus 702. In an example embodiment, the processors 710 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 712 and a processor 714 that may execute the instructions 716. The term “processor” is intended to include multi-core processors that may comprise two or more independent processors (sometimes referred to as “cores”) that may execute instructions 716 contemporaneously. Although FIG. 7 shows multiple processors 710, the machine 700 may include a single processor with a single core, a single processor with multiple cores (e.g., a multi-core processor), multiple processors with a single core, multiple processors with multiple cores, or any combination thereof.

The memory 730 may include a main memory 732, a static memory 734, and a storage unit 736, all accessible to the processors 710 such as via the bus 702. The main memory 732, the static memory 734, and the storage unit 736 store the instructions 716 embodying any one or more of the methodologies or functions described herein. The instructions 716 may also reside, completely or partially, within the main memory 732, within the static memory 734, within the storage unit 736, within at least one of the processors 710 (e.g., within the processor's cache memory), or any suitable combination thereof, during execution thereof by the machine 700.

The I/O components 750 may include a wide variety of components to receive input, provide output, produce output, transmit information, exchange information, capture measurements, and so on. The specific I/O components 750 that are included in a particular machine 700 will depend on the type of machine 700. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion, and the grouping is in no way limiting. In various example embodiments, the I/O components 750 may include output components 752 and input components 754. The output components 752 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 757, environmental components 760, or position components 762, among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 757 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 762 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via a coupling 782 and a coupling 772, respectively. For example, the communication components 764 may include a network interface component or another suitable device to interface with the network 780. In further examples, the communication components 764 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a USB).

Moreover, the communication components 764 may detect identifiers or include components operable to detect identifiers. For example, the communication components 764 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 730, 732, 734, and/or memory of the processor(s) 710) and/or the storage unit 736 may store one or more sets of instructions 716 and data structures (e.g., software) embodying or utilized by any one or more of the methodologies or functions described herein. These instructions (e.g., the instructions 716), when executed by the processor(s) 710, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 716 and/or data. The terms shall accordingly be taken to include, but not be limited to, solid-state memories, and optical and magnetic media, including memory internal or external to the processors 710. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 780 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 780 or a portion of the network 780 may include a wireless or cellular network, and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (IxRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 716 may be transmitted or received over the network 780 using a transmission medium via a network interface device (e.g., a network interface component included in the communication components 764) and utilizing any one of a number of well-known transfer protocols (e.g., HTTP). Similarly, the instructions 716 may be transmitted or received using a transmission medium via the coupling 772 (e.g., a peer-to-peer coupling) to the devices 770. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 716 for execution by the machine 700, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
a computer-readable medium having instructions stored thereon, which, when executed by a processor, cause the system to:
obtain training data, the training data comprising values for a plurality of different features;
train a global machine learned model using a first machine learning algorithm by feeding the training data into the first machine learning algorithm during a fixed effect training process; and
train a first non-linear random effects machine learned model by feeding a subset of the training data into a second machine learning algorithm, the subset of the training data being limited to training data corresponding to a particular value of one of the plurality of different features.

2. The system of claim 1, wherein the system is further caused to:
perform one or more iterations of a machine learned model training process, the one or more iterations continuing until a convergence test is met, each iteration comprising the obtaining training data, training the global machine learned model, and training the first non-linear random effects machine learned model.

3. The system of claim 2, wherein each iteration further comprises:
training a second non-linear random effects machine learned model by feeding a second subset of the training data into a third machine learning algorithm, the second subset of the training data being limited to training data corresponding to a particular value of another of the plurality of different features.

4. The system of claim 1, wherein the system is further caused to perform dimension reduction on the subset by applying a transformation to the subset.

5. The system of claim 1, wherein the second machine learning algorithm is a Gaussian process.

6. The system of claim 1, wherein the system is further caused to:
feed candidate data into the global machine learned model, producing a first score;
feed the candidate data into the first non-linear random effects machine learned model, producing a second score; and
combine the first score and the second score into a ranking score, the ranking score used to rank the candidate data against other candidate data.

7. The system of claim 6, wherein the candidate data is job posting results from an online service.

8. A method comprising:
obtaining training data, the training data comprising values for a plurality of different features;
training a global machine learned model using a first machine learning algorithm by feeding the training data into the first machine learning algorithm during a fixed effect training process; and
training a first non-linear random effects machine learned model by feeding a subset of the training data into a second machine learning algorithm, the subset of the training data being limited to training data corresponding to a particular value of one of the plurality of different features.

9. The method of claim 8, further comprising:
performing one or more iterations of a machine learned model training process, the one or more iterations continuing until a convergence test is met, each iteration comprising the obtaining training data, training the global machine learned model, and training the first non-linear random effects machine learned model.

10. The method of claim 9, wherein each iteration further comprises:
training a second non-linear random effects machine learned model by feeding a second subset of the training data into a third machine learning algorithm, the second subset of the training data being limited to training data corresponding to a particular value of another of the plurality of different features.

11. The method of claim 8, further comprising performing dimension reduction on the subset by applying a transformation to the subset.

12. The method of claim 8, wherein the second machine learning algorithm is a Gaussian process.

13. The method of claim 8, further comprising:
feeding candidate data into the global machine learned model, producing a first score;
feeding the candidate data into the first non-linear random effects machine learned model, producing a second score; and
combining the first score and the second score into a ranking score, the ranking score used to rank the candidate data against other candidate data.

14. The method of claim 13, wherein the candidate data is job posting results from an online service.

15. A non-transitory machine-readable storage medium comprising instructions which, when implemented by one or more machines, cause the one or more machines to perform operations comprising:
obtaining training data, the training data comprising values for a plurality of different features;
training a global machine learned model by feeding the training data into the first machine learning algorithm during a fixed effect training process; and
training a first non-linear random effects machine learned model using a second machine learning algorithm by feeding a subset of the training data into a second machine learning algorithm, the subset of the training data being limited to training data corresponding to a particular value of one of the plurality of different features.

16. The non-transitory machine-readable storage medium of claim 15, wherein the operations further comprise:
performing one or more iterations of a machine learned model training process, the one or more iterations continuing until a convergence test is met, each iteration comprising the obtaining training data, training the global machine learned model, and training the first non-linear random effects machine learned model.

17. The non-transitory machine-readable storage medium of claim 16, wherein each iteration further comprises:
training a second non-linear random effects machine learned model by feeding a second subset of the training data into a third machine learning algorithm, the second subset of the training data being limited to training data corresponding to a particular value of another of the plurality of different features.

18. The non-transitory machine-readable storage medium of claim 15, wherein the operations further comprise performing dimension reduction on the subset by applying a transformation to the subset.

19. The non-transitory machine-readable storage medium of claim 15, wherein the second machine learning algorithm is a Gaussian process.

20. The non-transitory machine-readable storage medium of claim 15, wherein the operations further comprise:
feeding candidate data into the global machine learned model, producing a first score;
feeding the candidate data into the first non-linear random effects machine learned model, producing a second score; and
combining the first score and the second score into a ranking score, the ranking score used to rank the candidate data against other candidate data.
